(19) United States
(12) Patent Application Publication
(10) Pub. No.: US 2013/0162661 A1
(43) Pub. Date: Jun. 27, 2013

(54) SYSTEM AND METHOD FOR LONG RUNNING COMPUTE USING BUFFERS AS TIMESLICES

(71) Applicants: Jeffrey A. Bolz, Austin, TX (US); Jeff Smith, Santa Clara, CA (US); Jesse Hall, Santa Clara, CA (US); David Sodman, Fremont, CA (US); Philip Cuadra, San Francisco, CA (US); Naveen Leekha, Fremont, CA (US)

(72) Inventors: Jeffrey A. Bolz, Austin, TX (US); Jeff Smith, Santa Clara, CA (US); Jesse Hall, Santa Clara, CA (US); David Sodman, Fremont, CA (US); Philip Cuadra, San Francisco, CA (US); Naveen Leekha, Fremont, CA (US)

(73) Assignee: NVIDIA CORPORATION, Santa Clara, CA (US)

(21) Appl. No.: 13/333,920

(22) Filed: Dec. 21, 2011

(51) Int. Cl. G06T 1/00

(52) U.S. Cl. 345/522

(57) ABSTRACT

A system and method for using command buffers as timeslices or periods of execution for a long running compute task on a graphics processor. Embodiments of the present invention allow execution of long running compute applications with operating systems that manage and schedule graphics processing unit (GPU) resources and that may have a predetermined execution time limit for each command buffer. The method includes receiving a request from an application and determining a plurality of command buffers required to execute the request. Each of the plurality of command buffers may correspond to some portion of execution time or timeslice. The method further includes sending the plurality of command buffers to an operating system operable for scheduling the plurality of command buffers for execution on a graphics processor. The command buffers from a different request are time multiplexed within the execution of the plurality of command buffers on the graphics processor.

### FIELD OF THE INVENTION

Embodiments of the present invention are generally related to execution on a graphics processing unit (GPU).

### BACKGROUND OF THE INVENTION

As computer systems have advanced, graphics processing units (GPUs) have become increasingly advanced both in complexity and computing power. As a result of this increase in processing power, GPUs are now capable of executing both graphics processing and more general computing tasks. Prior to recent changes in the operating system, the graphics driver had complete control how memory allocations were done, how work was submitted to the GPU and how work was scheduled on the GPU. More recent operating systems have taken over handling of memory allocations and scheduling of GPU resources. Modern operating systems generally limit a task operating on a GPU to two seconds or less before the GPU is reset and the task data lost.

GPUs have evolved to run interactive graphics applications where a frame generally takes a small fraction of a second to complete. GPUs have thus been designed to switch between tasks with a wait for completion granularity in order to simplify design. However, non-interactive graphics applications or compute algorithms are computationally intensive and may require seconds, minutes, or even days to complete. This requires developers of compute applications to unfortunately split work into multiple batches if the systems is to remain interactive.

Unfortunately, this splitting of work can be difficult. For example, an operating system driver model may require that a piece of work complete quickly to ensure the system remains interactive. The operating system may limit the amount of time a piece of work may execute before the operating system stops the work and resets corresponding portions of the GPU. This work stoppage causes the results of the work to be lost which limits and forward progress of the application.

### SUMMARY OF THE INVENTION

Accordingly, what is needed is a solution to allow GPU execution of computationally intensive algorithms which take more time to complete than provided by the operating system. Further, a solution is needed to allow the scheduling of long running compute work on a GPU within the limits of the operating system scheduler. Embodiments of the present invention support reinterpretation of an operating system's driver model concepts to support long running compute on the GPU while maintaining the use of the GPU as a graphics device. Embodiments of the present invention allow execution of long running compute application with operating systems that manage and schedule graphics processing unit (GPU) resources. Thus, execution of long running compute applications which exceed time limits imposed by the operating system is made possible by time multiplexing GPU processing tasks.

In one embodiment, the present invention is directed toward a computer implemented method for processing requests (e.g., requests to be processed by a GPU). The method allows long running tasks to be broken down into several short running command buffer allocations to a GPU, and in between, other tasks can be time multiplexed on the GPU, e.g., graphics tasks. In this manner, the GPU can be shared to do general computation and graphics tasks without any noticeable screen delay for graphics user interfaces. The method includes receiving a request from an application (e.g., a compute application) and determining a plurality of command buffers required to execute the request. The request may comprise general computational work for execution on a graphics processor. Each of the plurality of command buffers may correspond to some portion of execution time or timeslice on the GPU. Each of the plurality of command buffers may comprise an allocation identifier (AID) corresponding to a context associated with the request and a plurality of memory allocations. The method further includes sending the plurality of command buffers to an operating system operable for scheduling the plurality of command buffers for execution on a graphics processor. In one embodiment, the operating system has a predetermined execution time limit for each of the plurality of command buffers. The command buffers from a different request are time multiplexed within the execution of the plurality of command buffers on the graphics processor. The sending step may comprise sending a portion of the plurality of command buffers at a predetermined interval (e.g., a “heartbeat” of command buffers). In one embodiment, a plurality of commands for a graphics processing unit (GPU) associated with the plurality of command buffers are accessed directly by the GPU via a sideband mechanism.

In one embodiment, the present invention is a computer implemented method for executing a plurality of command buffers. The method allows long running tasks to be broken down into several short running command buffer allocations to a GPU, and in between, other tasks can be time multiplexed on the GPU, e.g., graphics tasks. In this manner, the GPU can be shared to do general computation and graphics tasks without any noticeable screen delay for graphics user interfaces. The method includes accessing a first command buffer and determining a first context for the first command buffer. The method further includes executing the first command buffer for a period of time on a graphics processor and accessing a second command buffer. The first command buffer and the second command buffer may be scheduled by an operating system (e.g., based on a driver model). The first command buffer and the second command buffer may respectively comprise memory allocations. The first command buffer and the second command buffer may each comprise a respective context or allocation identifier (AID) operable for use in allocation of new memory. The method further includes determining a second context for the second command buffer and executing the first command buffer for the period of time on the graphics processor when the first context is the same as the second context (e.g., the first command buffer and the second command buffer correspond to a compute application). When the first context and the second context are different, the execution of the first buffer may be preempted. For example, the first command buffer may be based on a request from a compute application and the second command buffer may be based on a request from a graphics application and thus the compute application is preempted to run the graphics application.

In another embodiment, the present invention is implemented as a graphics processing system. The system allows long running tasks to be broken down into several short running command buffer allocations to a GPU, and in between, other tasks can be time multiplexed on the GPU, e.g., graphics tasks. In this manner, the GPU can be shared to do general computation and graphics tasks without any noticeable screen delay for graphics user interfaces. The system includes a user mode module operable for receiving a plurality of requests for work to be completed on a graphics processor. The plurality of requests may be from a compute application. The user mode module is operable to determine a plurality of command buffers based on the plurality of requests. The plurality of command buffers may be scheduled by an operating system. Each of the plurality of command buffers corresponds to a predetermined amount of execution time on the graphics processor. In one embodiment, the user mode module is further operable for sending a portion of the plurality of command buffers at a predetermined interval. Each of the plurality of command buffers may comprise an allocation identifier (AID) corresponding to a context. Each of the plurality of command buffers may further comprise a plurality of memory allocations. The system further includes a kernel mode module operable for preempting a given command buffer executing on the graphics processor. The kernel mode module is further operable to preempt a given command buffer of the plurality of command buffers based on a context of the command buffer. In one embodiment, a plurality of commands for a graphics processing unit (GPU) associated with the plurality of command buffers are accessed directly by the GPU via a sideband mechanism.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 shows a computer system in accordance with one embodiment of the present invention.

FIG. 2 shows a block diagram of an exemplary operating environment in accordance with one embodiment of the present invention.

FIG. 3A shows a block diagram of exemplary execution order of command buffers in accordance with one embodiment of the present invention.

FIG. 3B shows a block diagram of exemplary components of a computer controlled system in accordance with one embodiment of the present invention.

FIG. 4 shows a block diagram of an exemplary dataflow diagram during allocation of additional memory in accordance with one embodiment of the present invention.

FIG. 5 shows a timing diagram of exemplary timeslices, in accordance with one embodiment of the present invention.

FIG. 6 shows a data diagram of exemplary semaphores and methods, in accordance with one embodiment of the present invention.

FIG. 7 shows a flowchart of an exemplary computer controlled process for processing requests in accordance with one embodiment for timeslicing GPU tasks using a command buffer architecture.

FIG. 8 shows a flowchart of an exemplary computer controlled process for executing a plurality of command buffers in accordance with one embodiment of the present invention for timeslicing GPU tasks using a command buffer architecture.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

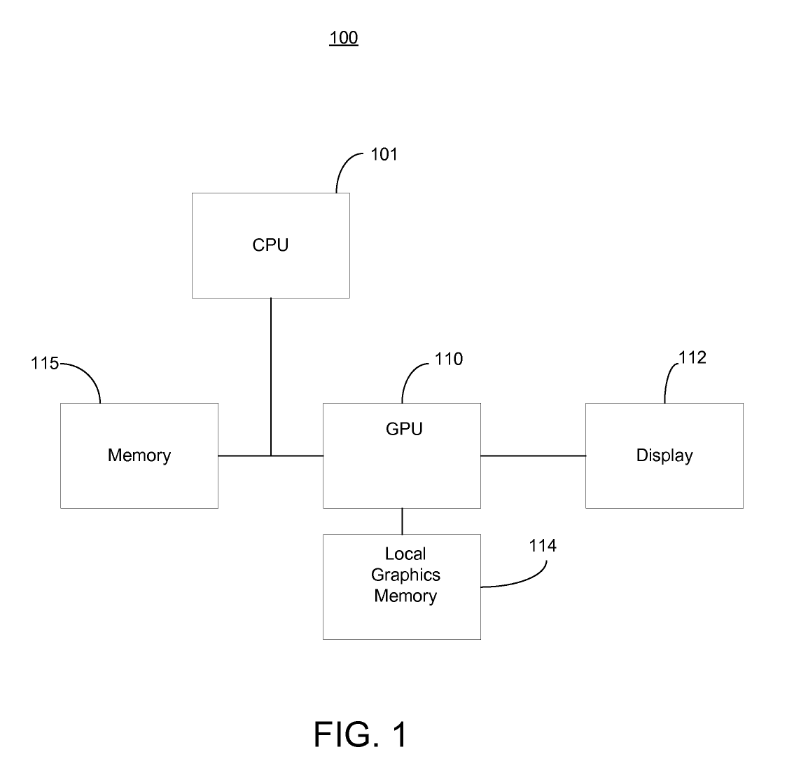

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “ processing” or “accessing” or “ executing” or “ storing” or “rendering” or the like, refer to the action and processes of an integrated circuit (e.g., computing system 100 of FIG. 1), or similar electronic computing device, that manipulates and transforms data represented as physical (electronic) quantities within the computer system's registers and memories into other data similarly represented as physical quantities within the computer system memories or registers or other such information storage, transmission or display devices.

### COMPUTER SYSTEM ENVIRONMENT

FIG. 1 shows a computer system 100 in accordance with one embodiment of the present invention. Computer system 100 depicts the components of a basic computer system in accordance with embodiments of the present invention providing the execution platform for certain hardware-based and software-based functionality. In general, computer system 100 comprises at least one CPU 101, a system memory 115, and at least one graphics processor unit (GPU) 110. The CPU 101 can be coupled to the system memory 115 via a bridge component/memory controller (not shown) or can be directly coupled to the system memory 115 via a memory controller (not shown) internal to the CPU 101. The GPU 110 may be coupled to a display 112. One or more additional GPUs can optionally be coupled to system 100 to further increase its computational power. The GPU(s) 110 is coupled to the CPU 101 and the system memory 115. The GPU 110 can be implemented as a discrete component, a discrete graphics card designed to couple to the computer system 100 via a connector (e.g., AGP slot, PCI-Express slot, etc.), a discrete integrated circuit die (e.g., mounted directly on a motherboard), or as an integrated GPU included within the integrated circuit die of a computer system chipset component (not shown). Additionally, a local graphics memory 114 can be included for the GPU 110 for high bandwidth graphics data storage.

The CPU 101 and the GPU 110 can also be integrated into a single integrated circuit die and the CPU and GPU may share various resources, such as instruction logic, buffers, functional units and so on, or separate resources may be provided for graphics and general-purpose operations. The GPU may further be integrated into a core logic component. Accordingly, any or all the circuits and/or functionality described herein as being associated with the GPU 110 can also be implemented in, and performed by, a suitably equipped CPU 101. Additionally, while embodiments herein may make reference to a GPU, it should be noted that the described circuits and/or functionality can also be implemented and other types of processors (e.g., general purpose or other special-purpose coprocessors) or within a CPU.

System 100 can be implemented as, for example, a desktop computer system or server computer system having a powerful general-purpose CPU 101 coupled to a dedicated graphics rendering GPU 110. In such an embodiment, components can be included that add peripheral buses, specialized audio/video components, IO devices, and the like. Similarly, system 100 can be implemented as a handheld device (e.g., cellphone, etc.), direct broadcast satellite (DBS)/terrestrial set-top box or a set-top video game console device such as, for example, the Xbox®, available from Microsoft Corporation of Redmond, Wash., or the PlayStation3®, available from Sony Computer Entertainment Corporation of Tokyo, Japan. System 100 can also be implemented as a “system on a chip”, where the electronics (e.g., the components 101, 115, 110, 114, and the like) of a computing device are wholly contained within a single integrated circuit die. Examples include a hand-held instrument with a display, a car navigation system, a portable entertainment system, and the like.

### EXEMPLARY OPERATING ENVIRONMENT

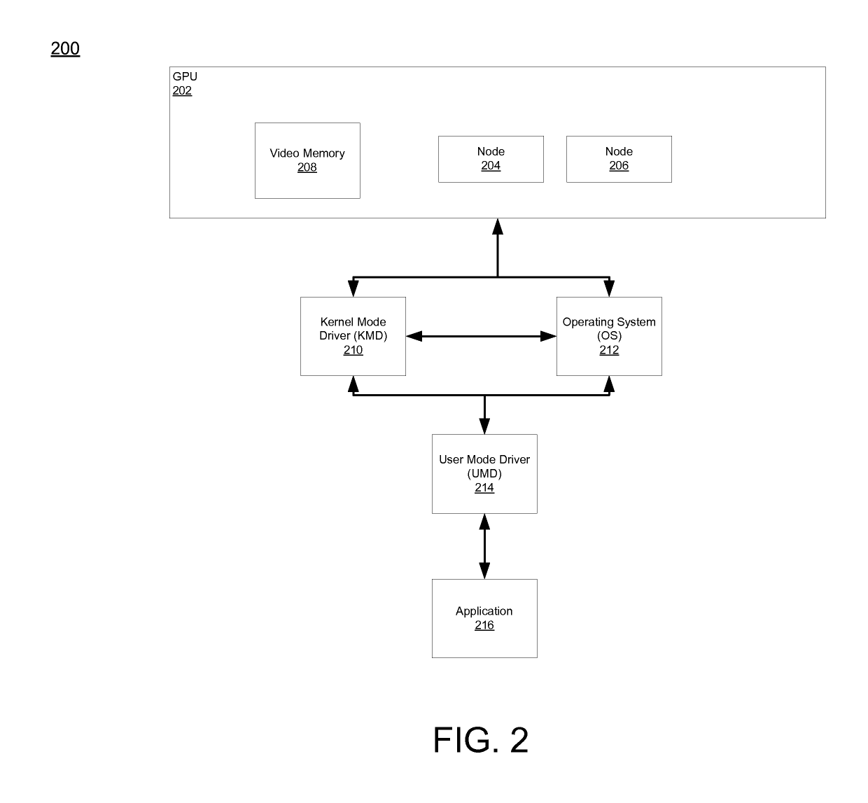

FIG. 2 shows a block diagram of an exemplary operating environment, in accordance with an embodiment of the present invention. Operating environment 200 includes graphics processing unit (GPU) 202, kernel mode driver (KMD) 210, operating system (OS) 212, user mode driver (UMD) 214, and application 216. Operating environment 200 depicts an operating environment where an operating system handles scheduling and allocation of GPU resources.

In one embodiment, exemplary operating environment is substantially based on Windows Display Driver Model (WDDM) 1.0, available from Microsoft Corporation of Redmond, Wash. It is appreciated that embodiments may operate with other versions of WDDM (e.g., WDDM 1.1, 1.2, 2.0, 2.1, etc.) and other graphic driver architectures. One goal of a driver model is to virtualize memory (e.g., allowing surfaces to be paged out to system memory or disk when the surfaces are not needed). Portions of work are submitted to operating system 212 as a command buffer by user mode driver 214. Operating system 212 receives information of memory allocations, command buffer submissions, and which command buffers submissions use which memory allocations from user mode driver 214. Operating system 212 uses this information to move allocations of memory around between execution of command buffers and restricts how many command buffers can execute at a time.

In one embodiment, operating system 212 is architected in such a way as to rely on the command buffers completing quickly for the system to remain interactive and will forcefully tear down any graphics context whose command buffer takes more than a predetermined period, e.g., two seconds, to complete. A portion of the GPU may then be reset and reinitialized if this period is violated. This two second time period may be known as Timeout Detection and Recovery (TDR). Timeout detection and recovery may be an operating system mechanism to detect when a GPU has hung and defines a period of time in which submitted command buffers need to complete. For example, where the user interface is built on top of the GPU, work that takes too long to complete may negatively impact the responsiveness of the user interface. Even if there is no timeout detection, often there are other assumptions built into an operating system that command buffers complete quickly and the system will become unresponsive if they do not complete quickly. Although embodiments of the present invention provide for long running compute tasks, they nevertheless contemplate operation on a computer system that uses an operating system with the TDR, as described above.

Referring to FIG. 2, GPU 202 includes video memory 208 (e.g. local graphics memory 114), node 204, and node 206. Nodes may correspond to independently executing portions of GPU 202 (e.g., graphics engine, copy engine such as a direct memory access (DMA) engine, a video engine, video decode engine, video encode engine, etc.). Each node may run autonomously and a scheduler (not shown) of operating system 212 may treat each node autonomously and sort the corresponding schedules for each node independently. In one embodiment, kernel mode driver 210 exposes a fixed number of nodes. For each piece of work that application 216 issues to user mode driver 214, the work is divided into packets known as command buffers. Each command buffer may run up to two seconds and if the command buffer takes longer, then the command buffer is killed or erased, and an error is provided to application 216. For graphics applications, a command buffer exceeding the time limit may result in a dropped frame or other error of minimal impact. For a compute application, a command buffer getting killed can be problematic because if the data is not stored out to memory, the next step in the compute application cannot be performed and/or the compute application may need to be restarted. The embodiments of the present invention provide an architecture to allow long running compute tasks which avoid the above referenced problem of buffer kill.

Under WDDM 1.0, the operating system (e.g., operating system 212) manages the memory used by tasks and the memory kept resident while the task is running WDDM 1.0 supports only one command buffer running at a time on a node, and the command buffer runs to completion before the next command buffer begins executing. A command buffer may correspond to a fixed amount of work to be completed prior to the time limit.

In one embodiment, GPU 202 supports executing a long running compute program and interrupting the program, taking the long running compute program off the GPU, executing another program, and then resuming the long running compute program. In one exemplary embodiment, a long running compute task (LRC) may be, in one example, considered a task that does not necessarily need interactive response, can deal with high latency, and should generally be lower priority than interactive graphics, but needs to make forward progress over time. Embodiments of the present invention support and enable long running compute (e.g., Compute Unified Device Architecture (CUDA) or Open Computing Language (OpenCL)) which allows computationally intensive computations to exceed the TDR limits (e.g., time limits) imposed by the operating system. Embodiments of the present invention further support hardware that supports preempting compute work at a much finer granularity than provided with current operating systems. Embodiments of the present invention further support method based or function based granularity which advantageously provides better granularity than command buffer granularity.

In one exemplary embodiment, GPU 202 executes a compute program divided into cooperative thread arrays (CTAs). In other words, the work may be divided into threads and some of the threads are closely grouped together, can cooperate, and run together on the same hardware execution units. In one embodiment, CTAs are queued up using the command buffer architecture and each executes until completion and cannot be interrupted but preemption can be performed between CTAs. Embodiments of the present invention are able to support any of a variety of levels of preemption including, but not limited to, instruction level preemption, CTA boundary preemption, or method granularity preemption. Embodiments of the present invention thus support preemption at a level beyond what the operating system provides.

User mode driver 214 creates a context on the node (e.g., node 204 or 206) corresponding to the engine or node where the context will execute. In one embodiment, a context represents a stream of work (e.g., graphics commands or compute commands) coming from a single central processing unit (CPU) thread and the persistent states that the thread is using (e.g., similar to a context in Direct3D or Open Graphics Library (OpenGL)). Several CTAs may be required to complete a piece of work. User mode driver 214 further creates memory allocations through operating system 212 and kernel mode driver 210. Each context may be sent to operating system 212 and kernel mode driver 210 via corresponding command buffers.

Application 216 provides work to user mode driver 214 which in turn determines one or more command buffers containing that work, an allocation list (AL), and a patch location list (PLL) for each time that work references memory. When the command buffer is full or application 216 requests a “flush,” user mode driver 214 sends the accumulated command buffer, AL, and PLL to operating system 212 through a render command.

Operating system 212 determines when a command buffer will be run and ensures that the allocations the command buffer uses are present in memory. Operating system 212 further requests kernel mode driver 210 to patch physical addresses in the command buffer. In one embodiment, patching may be skipped because allocations may have static GPU virtual addresses that do not need patching.

Operating system 212 then submits the command buffer to the kernel mode driver 210 based on scheduling determined by operating system 212. In one embodiment, a scheduler (not shown) of operating system 212 queues up the command buffers of work and submits them to kernel mode driver 210. Kernel mode driver 210 schedules the command buffer on the GPU as the next thing on the corresponding node to be executed. In one embodiment, command buffers from a respective context are executed in the order the command buffers are given to user mode driver 214.

When the work corresponding to the command buffer is completed, GPU 202 raises an interrupt and kernel mode driver 210 signals operating system 212 that the command buffer has completed. Operating system 212 may then determine that GPU 202 no longer needs the memory referenced by the completed command buffer and the memory is available to be paged out until the memory is needed again.

### EXEMPLARY SYSTEMS AND METHODS FOR LONG RUNNING COMPUTE USING BUFFERS AS TIMESLICES

Embodiments of the present invention support reinterpretation of the driver model's concepts to support long running compute tasks while still using an operating system having a restrictive TDR. In other words, long running compute tasks can thus be accomplished on WDDM by treating command buffers as “timeslices” of work to make progress on a task rather than a fixed quantity of work to be completed. Preemption may be used to end a timeslice. The duration of the timeslice can be quite small, e.g., 5 ms. In one embodiment, user mode drivers and kernel mode drivers implement functionality to accomplish long running compute. Embodiments of the present invention use command buffers to get memory allocations resident in the GPU thereby giving a context to a timeslice on the GPU to execute. The command buffer for a CTA also defines the context, e.g., task ID, to which the CTA belongs. Embodiments of the present invention allow two applications whose combined working sets may exceed the amount of memory on the GPU to execute on the GPU while each individual working set may be less than the amount of memory on the GPU.

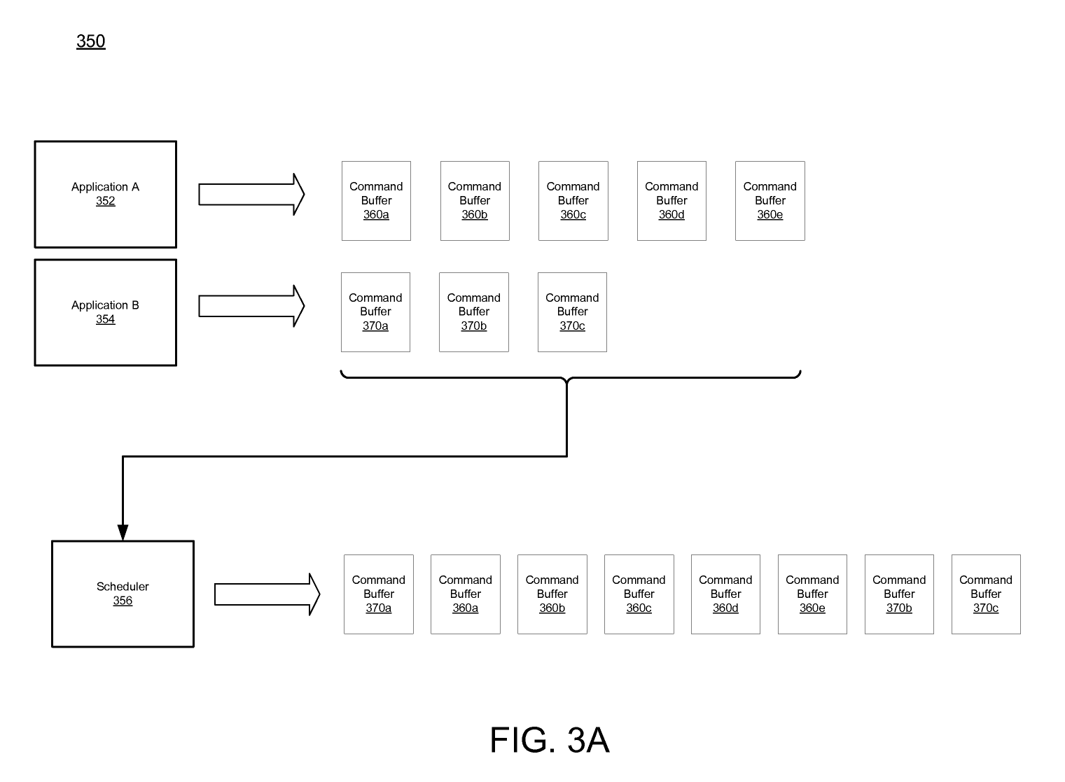

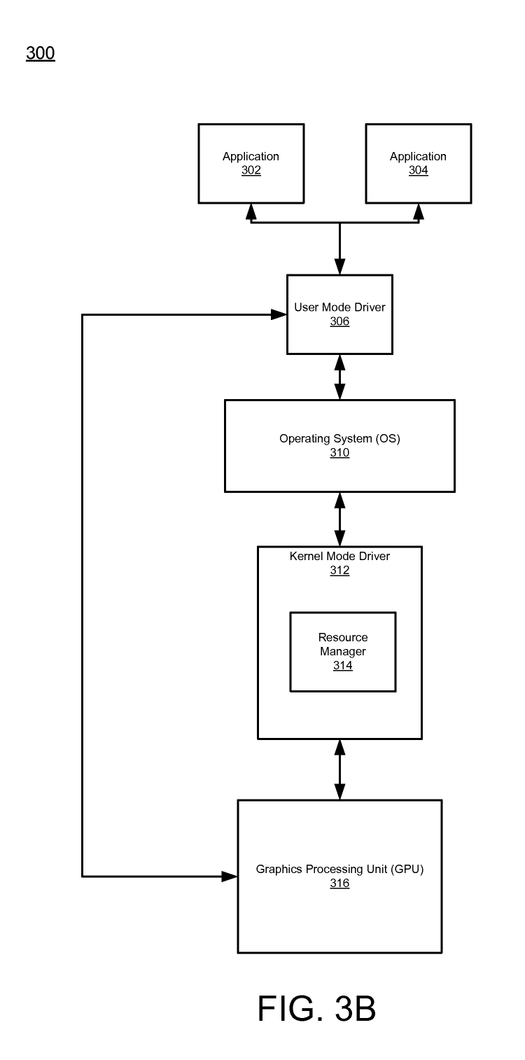

FIG. 3A shows a block diagram of exemplary execution order of command buffers in accordance with one embodiment of the present invention. Diagram 350 depicts a plurality of command buffers based on requests from an application and an exemplary execution order. Diagram 350 includes application A 352, application B 354, command buffers 360a-e, command buffers 370a-c, and scheduler 356. Command buffers 360a-e and 370a-c may each correspond to respective timeslices of execution.

Embodiments of the present invention are operable to determine command buffers based on requests from applications. For example, command buffers 360a-e are based on work or requests from application A 352 and command buffers 370a-c are based on requests from application B 354. In one embodiment, application A 352 is a compute application and application B 354 is a graphics application.

Command buffers 360a-e and command buffers 370a-c are accessed by scheduler 356. In one embodiment, scheduler 356 is part of an operating system and may be operable to be controlled by a kernel mode driver. Scheduler 356 is operable to schedule command buffers for execution on a graphics processor of a graphics processing unit (GPU). Scheduler 356 is operable to interleave command buffers from different applications for execution.

Command buffers 360a-e may be from a long running compute application and command buffers 370a-c may be from a graphics applications. In one exemplary embodiment, command buffer 370a, which is based on application B 354, is accessed and executed first. Then command buffers 360a-e may be executed. Embodiments of the present invention are operable to continue executing subsequent command buffers of the same context (e.g., of a compute application). Command buffer 360e may then be preempted and command buffers 370b-c may then be executed. Embodiments of the present invention thus support graphics processor execution being shared for general computation and graphics tasks without any noticeable screen delay for graphics user interfaces.

FIG. 3B illustrates example components of a computer controlled system used by various embodiments of the present invention. Although specific components are disclosed in system 300, it should be appreciated that such components are examples. That is, embodiments of the present invention are well suited to having various other components or variations of the components recited in system 300. It is appreciated that the components in system 300 may operate with other components than those presented, and that not all of the components of system 300 may be required to achieve the goals of system 300.

Diagram 300 includes applications 302-304, user mode driver 306, operating system 310, and graphics processing unit (GPU) 316. Diagram 300 depicts the data flow of requests from applications 302-304 to GPU 316 via user mode driver 306 and operating system 310. Embodiments of the present invention facilitate execution of requests from applications 302-304 during individual timeslices on GPU 316. Each timeslice may correspond to a CTA or a plurality of CPAs and may use a command buffer technique to send the GPU. User mode driver 306, operating system 310, kernel mode driver 312 may be executed by a CPU (e.g., CPU 101).

In one embodiment, GPU 316 comprises a long running compute node for running long running compute tasks. Short running compute tasks may executed on different nodes. A short running compute application may have similar latency requirements as a graphics application and could be a compute task created by a graphics application and may require real time processing time constraints.

Embodiments of the present invention treat a command buffer as a request for a timeslice running on the GPU, rather than as a fixed quantity of work that needs to be completed. In one embodiment, the command buffers still flow through the operating system and the kernel mode driver as before but there may be no commands in the command buffer directly corresponding to the command buffer's execution. The actual commands may be provided to the GPU separately (e.g., by user mode driver 306) via a sideband technique. The command buffer may thus be substantially an allocation list and serves to inform the operating system which allocations are to be present in memory while a context corresponding to the command buffer executes. The command buffer may similarly identify the context to which it belongs. Operating system 310 is responsible for ensuring that the allocations are resident on the GPU before operating system 310 sends a command buffer to the GPU. Operating system 310 prior to executing a command buffer may submit a set of paging work, to move allocations from the previously running command buffer out of GPU memory and move allocations for the next command buffer about to execute into GPU memory.

Generally, the input and output for a task is video memory that can be read or written at any time. The video memory may be described to operating system 310 as a set of allocations. Each application may have a corresponding set of memory allocations. The memory allocations for an application are performed prior to the referencing of the memory in a command buffer. In one embodiment, the memory allocations are resident before the command buffer can execute or before the duration of the command buffer is executed. For CUDA applications, this may be the entire set of allocations that the application has live at that point. For graphics applications, it may be a smaller set of allocations. Operating system 310 may use the command buffers to track what memory is in use.

In one embodiment, the user mode driver creates a “context” on a GPU node. A context is a stream of graphics command or compute commands that are created on one node. The user mode driver then submits the work on the node as a series of CTAs. Each CTA may be a separate command buffer or a command buffer may correspond to multiple CTAs. The scheduler in the operating system queues up the command buffers of work and then submits them to the GPU kernel mode driver and then to the hardware.

A “heartbeat” of command buffers is a set of command buffers that correspond to timeslices of work. In one exemplary embodiment, the user mode driver 306 submits a heartbeat of command buffers to operating system 310 to request that the context corresponding to the command buffers has an opportunity to execute. In one embodiment, a heartbeat buffer is small command buffer submitted on a regular “heartbeat” basis used to ensure that operating system 310 maintains the memory resources used by a long running compute application resident in memory. The heartbeat of command buffers may be submitted by user mode driver 306 based on receiving commands or requests from application 302-306 which make graphics processing requests. User mode driver 306 may then submit the command buffers to operating system 310 which may time interleave the command buffers corresponding to each application.

The heartbeat of command buffers may comprise a list of memory objects and each subsequent heartbeat of command buffers that uses that memory comprises the same list of memory objects for a given context. User mode driver 306 may thus use the same list of memory objects for a plurality of heartbeat command buffers until user mode driver 306 receives a signal that the work corresponding to the plurality of heartbeat command buffers has completed. It is noted that a particular task or request may likely be split over multiple respective command buffers.

In one embodiment, a heartbeat of command buffers is submitted every N milliseconds. The heartbeat of buffers may function as a request to get a context scheduled for a portion of work. When a context is executing, the context may execute until it completes, determines that it needs to be preempted, or the kernel mode driver preempts the context in response to some external stimulus. Operating system 310 may then deliver the heartbeat of buffers to kernel mode driver 312. For example, each command buffer may correspond to a short timeslice (e.g., 5 milliseconds) in order to maintain system responsiveness. Thus, embodiments of the present invention support a long running compute application executing for short time (e.g., a few milliseconds), then switching over to an interactive application (e.g., interactive graphics application), and then back again, etc.

In one embodiment, the command buffers of the heartbeat of command buffers comprise memory allocation definitions, context identifier (ID), and the corresponding commands may be sent to the GPU through a sideband mechanism, e.g., user mode driver 306 may write to memory that the GPU 316 can read (e.g., local graphics memory 114). It is noted that embodiments of the present invention may thus avoid the extra costs (e.g., processing time and performance) of copying the commands (e.g., to operating system 310).

It is noted that embodiments of the present invention utilize command buffer execution as a fixed amount of time whereas the operating system driver model treats command buffers as a list of tasks to be completed. At the end of each command buffer, the hardware (e.g., GPU) raises an interrupt to kernel mode driver which calls an operating system function to signal that the command buffer has completed. An interrupt may thus be raised at the end of each timeslice.

In one embodiment, kernel mode driver 312 manages a software timer or preemption timer which defines an interval in which to process a heartbeat of command buffers. Based on the software timer, the CPU may send an interrupt to cause preemption on the GPU. In another embodiment, the hardware comprises a front end unit known as a “host” which fetches work and performs hardware level scheduling. In one exemplary embodiment, during a wait for idle mode, the host unit may wait for the hardware (e.g., GPU) to go idle before sending the next set of commands. In another exemplary embodiment, the CPU may wait for the GPU to go idle. The host may be operable to issue an interrupt after a specified amount of time and thereby trigger a context switch without CPU involvement. Thus, embodiments of the present invention support either the CPU or GPU interrupting the GPU and signaling kernel mode driver 312 to signal operating system 310 of the context switch. Further, when GPU 316 raises the interrupt for the currently executing command buffer, GPU 316 may begin processing the next ready command buffer. Thus, GPU 316 does not have to wait for the latency of the CPU to process the interrupt from GPU 316 and call operating system 310.

In one embodiment, a scheduler (not shown) of operating system 310 may have a command buffer ready for execution while the current command buffer is executing to employ pipelining of the buffers. Prior to execution of a command buffer, the operating system scheduler determines if the memory allocations listed in the command buffer are resident in video memory. If the scheduler determines that the allocations are not resident in the video memory, the scheduler has the allocations paged into video memory.

Kernel mode driver 312 may track the time a command buffer has been executing and when the command buffer's timeslice expires, kernel mode driver 312 may either (1) allow the command buffer to execute if the next command buffer is from the same context, or (2) preempt the command buffer if the next command buffer is from a different context. In both cases, kernel mode driver 312 reports the command buffer's completion to operating system. Kernel mode driver 312 may also choose to end the timeslice early in order to allow higher-priority compute or graphics work from another node to run more quickly. In this fashion, command buffers can be viewed as time multiplexed subtasks of different contexts.

The number of command buffers submitted may be based on a number of allowed outstanding buffers by operating system 310. Generally, the buffers may hold identical information and the duplication allows for optimizations. In one embodiment, the command buffer includes a GpFIFO index that represents the last GpFIFO entry that requires the same set of allocations, an identifier that represents a specific set of allocations (or allocation identifier (AID)), and an acquire value. If the number of command buffers submitted is less than the number of command buffers required to finish the section, user mode driver 306 is operable to determine that so that additional command buffers can be submitted.

In one embodiment, user mode driver 306 is responsible for determining when to free a memory allocation, after each previous use of a memory allocation completes. When user mode driver 306 signals to free a memory allocation, operating system 310 does not actually release the memory until the previous command buffers that reference the memory complete. It is noted that since command buffers no longer correspond to fixed quantities of work, user mode driver 306 does not rely on command buffer completions to indicate that a node is done with a memory allocation and instead user mode driver 306 uses a signal that a node is done with a memory allocation to determine when to free a memory allocation. It is further noted that operating system 310 may move allocations around between timeslices, such that long running compute processes do not prevent other processes from having access to the memory. It is appreciated that memory may not be at the same physical address when the next timeslice begins.

In one embodiment, kernel mode driver 312 includes resource manager 314. A channel is a stream of work queued up for GPU 316 to process or execute. GPU 316 may switch between two channels. Resource manager 314 is operable to perform channel allocation which includes adding a channel to a runlist and marking the channel as runnable. The adding of a channel to a runlist and the marking of the channel as runnable can be done in multiple steps. For example, channel allocation (e.g., allocation of necessary resources) may be performed and then the channel may be scheduled (e.g., putting the appropriate channel on the appropriate runlist and marking the channel as schedulable).

In one embodiment, long running compute tasks start with context allocation. User mode driver 306 may call into operating system 310 to allocate the context. The context may be allocated to a long running compute node of GPU 316. The call to operating system 310 may in turn call kernel mode driver 312 to allocate the context which is performed by resource manager 314. In one embodiment, by default, resource manager 314 allocates the channel as a wait for idle (WFI) context channel and resource manager 314 allocates the necessary context buffer space for a wait for idle channel. At the point of allocation, the channel may not be on the runlist, nor marked as schedulable.

In one embodiment, long running compute tasks are preemptable and after the channel is marked schedulable, but before any compute work is submitted, user mode driver 306 allocates a preemption context buffer. User mode driver 306 then sends a method or function call which signals the microcode (e.g., microcode of the GPU) to use the full preemption buffer size. User mode driver 306 can also allocate or initialize a trap handler (not shown) for preemption and use methods to pass the trap handler data to the compute engine of GPU 316.

It is noted that under WDDM, compute contexts can be virtual contexts. Thus, when a channel is first enabled, a context buffer may not be mapped into the channel. In one embodiment, user mode driver 306 is responsible for allocating the full preemption context buffer and that buffer will be used to page in the initial context buffer. Even though the context buffer may be the full size of the preemption buffer, the channel at this point will be in wait for idle mode. Once a context buffer is paged in, user mode driver 306 will be able to send the method which provides the address of the preemption context buffer.

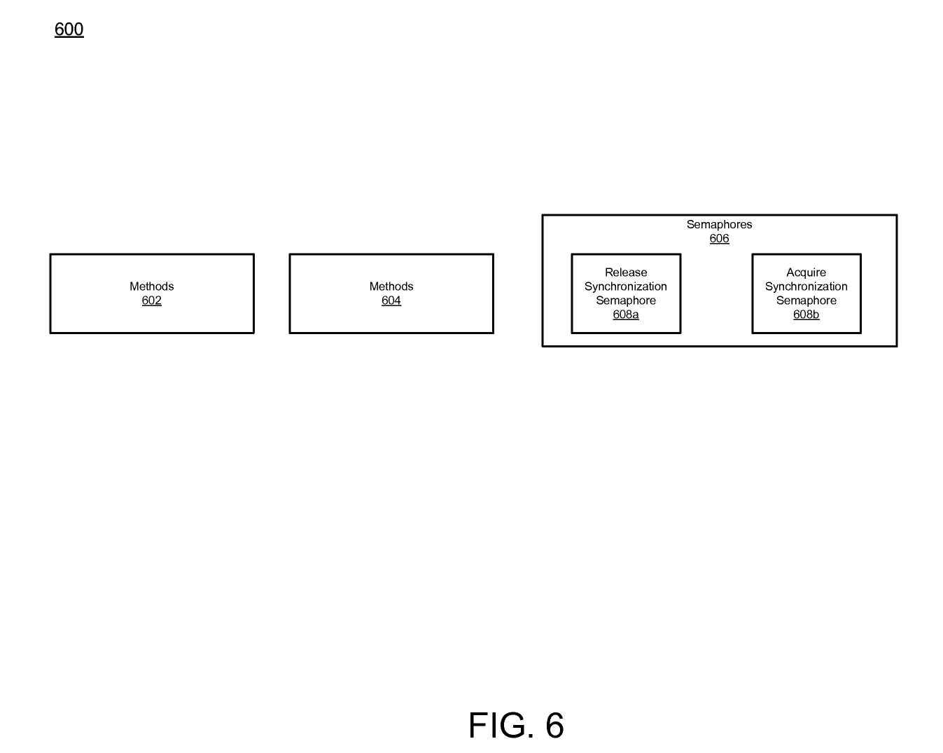

After channel allocation, kernel mode driver 312 requests resource manager 314 to put the channel on the runlist, which will also mark the channel as schedulable. In one embodiment, kernel mode driver 312 may then immediately use a channel control call to mark the channel as not schedulable. During the context allocation, kernel mode driver 312 allocates memory for two per-context synchronization semaphores (e.g., FIG. 6). Failure to allocate the two per-context synchronization semaphores causes kernel mode driver 312 to fail the context creation.

In one embodiment, the commands buffers from kernel mode driver 312 sent to GPU 316 are stored in a GpFIFO buffer. A section is a set of contiguous GpFIFO segments that each use the same set of allocations. User mode driver 312 may build the pushbuffer as a set of GpFIFO segments as previously done. At the end of each section, there is a semaphore release to the context release synchronization semaphore followed by an acquire to the context acquire synchronization semaphore (e.g., FIG. 6).

Embodiments of the present invention are thus operable for execution of long running compute tasks on WDDM 1.0 without any operating system changes and without circumventing Microsoft's driver model. Therefore, normal graphics operations are supported while long running compute tasks are done, e.g., in the background. Embodiments of the present invention use WDDM command buffers as timeslices rather than fixed quantities of work and treat WDDM nodes as a scheduler concept rather than being tied to a particular hardware unit. Embodiments of the present invention further allow long running compute that leverages WDDM 1.0 memory management between processes and memory can be paged out between timeslices.

Embodiments of the present invention support long running compute in conjunction with a virtual memory system, which allows memory to change physical locations between timeslices. Embodiments of the present invention further support treating a long running compute node as lower priority work than graphics and short running compute work, by preempting long running compute work when work is submitted on another higher-priority node. Embodiments of the present invention support optimizing back-to-back timeslices without preempting the compute context by making the kernel mode driver responsible for determining when to preempt. Embodiments further support dynamic memory allocation from compute shaders under WDDM. Embodiments of the present invention further allow using a long running compute scheme to enable debugging of compute nodes (e.g., shaders) on a single GPU. For example, the compute work can be preempted in the middle of execution (e.g., when a breakpoint fires).

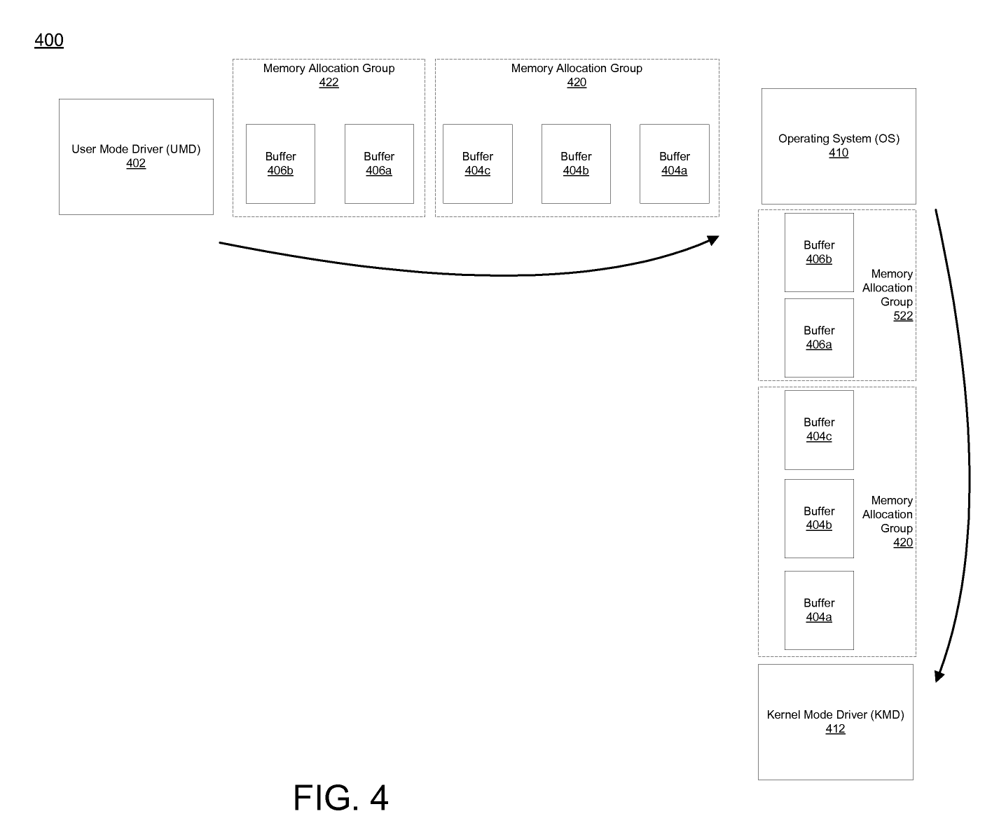

FIG. 4 shows a block diagram of exemplary dataflow diagram during allocation of additional memory in accordance with one embodiment of the present invention. Diagram 400 includes user mode driver (UMD) 402, operating system (OS) 410, and kernel mode driver (KMD) 412. Diagrams 400 depicts the flow of buffers 404a-c and 406a-b and corresponding memory allocation groups 420-422 as allocation of new memory is performed to facilitate completion of a heartbeat of command buffers.

Embodiments of the present invention further support long running compute programs that may need to allocate new memory (e.g., from compute shaders). Embodiments of the present invention are operable to allocate additional memory for execution of a command buffer. When a command buffer is determined to need more memory to execute, the command buffer is preempted thereby yielding its timeslice and a signal is sent back to the user mode driver indicating that more memory is needed for execution of the command buffer. On the next command buffer, user mode driver 402 can include more memory in the allocation list for that command buffer. For example, if a node determines new memory is needed to complete the work, the node can signal user mode driver 306 of the need for more memory, request the kernel mode driver 312 preempt the current command buffer, and user mode driver 306 can submit a new heartbeat of command buffers (e.g., command buffers 406a-b) with additional memory in the allocation list (e.g., memory allocation group 422). Embodiments of the present invention thus support synchronous callbacks for memory allocation.

Command buffers 404a-c, from memory allocation group 420, are sent from user mode driver 402 to operating system 410. Operating system 410 then sends command buffers 402a-c to kernel mode driver 412. In one embodiment, operating system 410 schedules and marks command buffers 402a-c for execution. In one exemplary embodiment, command buffers 402a-c have a context or allocation identifier (AID) (e.g., AID=1). In one embodiment, a portion of operating system 410 based on DirectX®, available from Microsoft Corporation of Redmond, Wash., receives command buffers 404a-c and 406a-b and sends command buffers 404a-c and 406a-b to kernel mode driver 412.

As described herein, a heartbeat buffer can represent a given amount of time of processing of a command. The heartbeat buffer may be duplicated in terms of submission to the operating system to allow multiple timeslices to progress. In one embodiment, user mode driver 402 may not track how many timeslices are needed to finish processing a segment (e.g., a portion of a GpFIFO buffer) and thus submits multiple instances. The number of heartbeat buffers submitted by user mode driver 402 may not match exactly the number of timeslices necessary to finish the section and may be more or less than needed. In one embodiment, the preference is for more command buffers to be submitted (e.g., but not too many more), which is dependent on the workload but is not necessarily guaranteed. User mode driver 402 is operable to determine if the number of heartbeat buffers submitted is less than the number of heartbeat buffers required to finish the section or work so that user mode driver 402 can submit more heartbeat buffers. Kernel mode driver 412 is operable to determine when the section or work is finished so that if more heartbeat buffers are submitted than is required to finish the section, kernel mode driver 412 can report the remaining heartbeat buffers as completed to operating system 410.

When user mode driver 402 starts a new section (e.g., a set of contiguous GpFIFO segments that each use the same set of allocations), user mode driver 402 will create a new allocation identifier (AID) and add the AID to the heartbeat buffers for the new section. Each time kernel mode driver 412 processes a preemption timer, kernel mode driver 412 will compare the AID in the heartbeat buffer with the AID in the context synchronization release semaphore. If the AID from the heartbeat buffer and the AID from the context synchronization release semaphore do not match then the heartbeat buffer is no longer valid. Kernel mode driver 412 will then preempt the long running compute that is running (e.g., command buffers 402a-c). The preemption may occur even if the kernel mode driver 412 would not have to preempt the long running compute due to the next heartbeat buffer (e.g., command buffer 406a) being from the same context. As a result of the preemption the channel is not enabled. Due to the section being finished, kernel mode driver 412 will signal operating system 410 that each heartbeat buffer for the context with the now invalid AID has completed.

The next set of heartbeat buffers (e.g., buffers 406a-b) will have a new AID (e.g., AID=2) and a new GpFIFO entry. Kernel mode driver 412 can then write a new AID value into the context synchronization acquire semaphore. In one embodiment, user mode driver 402 periodically reads the context synchronization acquire semaphore. When user mode driver 402 monitors the context synchronization acquire semaphore for updates to determine whether the section has completed. Lack of an update (e.g., over a specific period of time) to the context synchronization acquire semaphore may signal user mode driver 402 that user mode driver 402 has not submitted enough heartbeat buffers. Due to the pushbuffer having an acquire on the value, the act of writing the pushbuffer allows the hardware to proceed to the next GpFIFO segment once the channel is re-enabled.

In one embodiment, the GPU writes to a synchronization semaphore in memory which indicates the task that was completed (e.g., a number corresponding to the task that was completed). User mode driver 402 can then read the memory corresponding to the synchronization semaphore. In one embodiment, user mode driver 402 checks the synchronization semaphore prior to submitting a new command buffer to determine whether the GPU is processing a heartbeat of command buffers. User mode driver 402 may then remove memory allocations from subsequent command buffers for the command buffers have been completed.

Referring to FIG. 4, while the GPU is signaling user mode driver 402 that a new memory allocation is needed, user mode driver 402 may have queued up more command buffers that have been send to operating system 402 which still have the old allocation list (e.g., old allocation identifier).

At the end of the section, there will be a semaphore release (e.g., with the AID) written to the release synchronization semaphore that was allocated by kernel mode driver 412 at context creation time. Kernel mode driver 412 uses the release synchronization semaphore to determine when a section has ended which is used to control how kernel mode driver 412 processes a preemption timer.

Kernel mode driver 412 places the heartbeat buffers into a heartbeat buffer queue and starts processing the first entry into the queue. Kernel mode driver 412 records the AID associated with the heartbeat buffer. On the last GpFIFO entry of the section, there will be a release synchronization semaphore with AID value and an acquire synchronization semaphore. In one embodiment, the purpose of the release synchronization semaphore is to allow kernel mode driver 412 to determine that the allocation set is no longer valid. In one exemplary embodiment, the purpose of the acquire synchronization semaphore is to stop the hardware from processing until the new set of allocations are paged in.

Kernel mode driver 412 will process heartbeat buffers based on upon whether there are currently long running compute contexts running or if the heartbeat buffers correspond to a first long running compute context. In one embodiment, if the heartbeat buffers correspond to the first long running compute context to run, then kernel mode driver will allocate a notifier using NV2080_NOTFIERS_FIFO_EVENT_PREEMPT. Kernel mode driver 412 submits the GpFIFO data generated by user mode driver 402 to the hardware (e.g., along with the aforementioned kernel mode driver semaphores). Kernel mode driver 412 may then start a software preemption timer so that kernel mode driver 412 can preempt the context. If a long running compute context is already running, kernel mode driver 412 adds the received heartbeat buffer to the end of the queue of heartbeat buffers.

When the preemption timer expires, kernel mode driver 412 accesses the context associated with the next heartbeat buffer. If the context of the next heartbeat buffer is same as the currently running context, kernel mode driver 412 will restart the preemption timer and let the context continue. If the next heartbeat buffer is of a different context, kernel mode driver 412 may call NV0080_CTRL_CMD_FIFO_EVICT_ENGINE_CONTEXT passing the handle to the TSG (time slice group) or channel in the case of a single channel. In one embodiment, a resource manager (e.g., resource manager 314) initiates the preemption, and then updates corresponding data structures to indicate that a kernel initiated preemption is in progress and will return back. When the preemption is complete, the host or GPU may notify kernel mode driver 412 via an interrupt. As part of the handling of the interrupt, the resource manager will notify kernel mode driver 412 that the preemption is complete via the NV2080_NOTIFIERS_FIFO_EVENT_PREEMPT notifier previously setup by kernel mode driver 412. Kernel mode driver 412 may access the notifier when checking the notifier status at the end of the interrupt call.

In one embodiment, application programming interfaces (APIs) are modified to support long running compute contexts. A time slice group (TSG) is a set of hardware channels that are operable to work cooperatively together. In one embodiment, a time slice group (TSG) object is used which is a new object type that will be allocated by a client (e.g., kernel mode driver) and a resource manager provides a TSG handle (e.g., hTsg) to the client. In one embodiment, a TSG is not a channel per se but rather the TSG is treated as a channel by the runlist processor and is usable by clients in many places that a channel handle (e.g., hChannel) is used. For TSG allocation purposes, the parent of a TSG may be a device. In one embodiment, when a channel is allocated into a TSG, the parent of the channel is the TSG handle. Some changes may be made to resource channel allocation accordingly.

In one embodiment, a channel control call supports marking a channel enabled or disabled (e.g., A06F_CHANNEL_ENABLE). In one exemplary embodiment, this could be implemented as a single control call that takes an enable/disable parameter, or as two control calls (e.g., A06F_CHANNEL_ENABLE+A06F_CHANNEL_DISABLE). The control call may take a channel parameter that could be either a channel handle or a TSG handle. In one embodiment, if the parameter passed in is a channel handle, the operation applies to the channel. If the parameter passed in is a handle to a TSG, then the operation applies to each channel in the TSG.

Embodiments of the present invention support preemption via a NV2080_NOTIFIERS_FIFO_EVENT_PREEMPT object, a NV0080_CTRL_CMD_FIFO_EVICT_ENGINE_CONTEXT, and a NV00080_CRTL_CMD_FIFO_GET_ENGINE_CONTEXT_PROPERTIES. NV2080_NOTIFIERS_FIFO_EVENT_PREEMPT is a FIFO_EVENT_PREEMPT notifier index that is added to allow a kernel mode driver to request to be notified by the resource manager when preemption is completed. NV0080_CTRL_CMD_FIFO_EVICT_ENGINE_CONTEXT corresponds to a modified FIFO_EVICT_ENGINE_CONTEXT control call. In one embodiment, a non-blocking mode of operation is supported, such that a call can initiate a preemption operation in the context of the client calling thread, return back to the client before the hardware operation completes, and can notify the client via the interrupt that hardware generates on completion. NV00080_CRTL_CMD_FIFO_GET_ENGINE_CONTEXT_PROPERTIES corresponds to a GET_ENGINE_CONTEXT_PROPERTIES modified to accept a flag that determines whether the function will return the wait for idle context size or the PREEMPT context size.

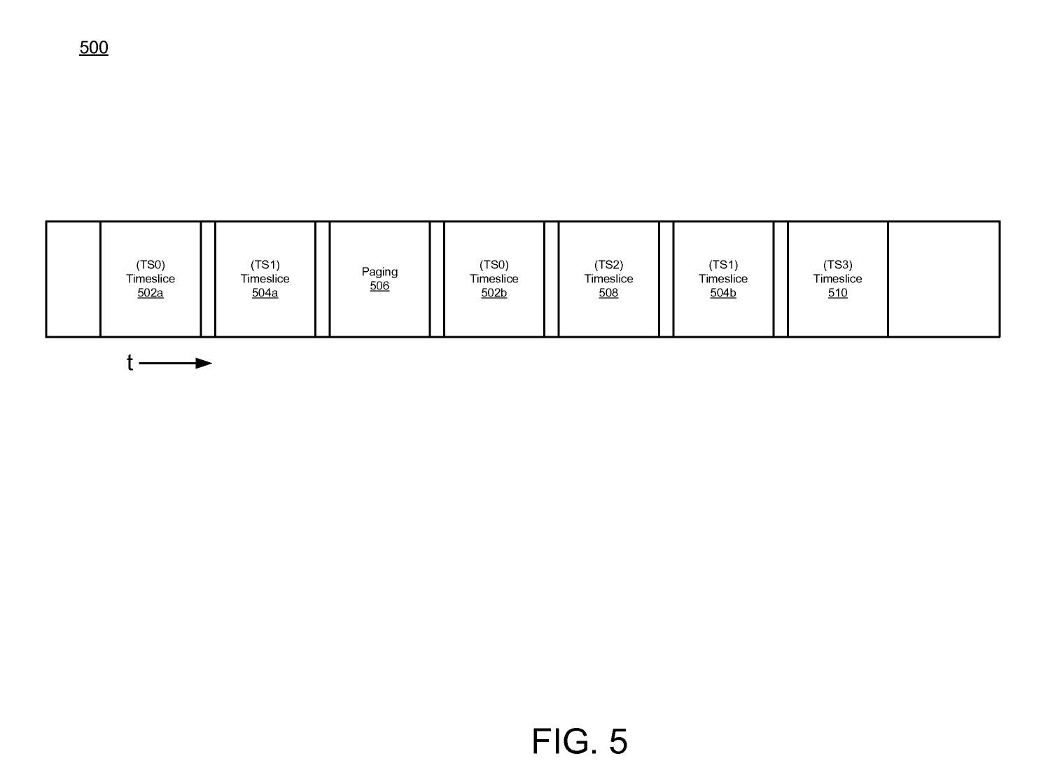

FIG. 5 shows a timing diagram of exemplary timeslices, in accordance with one embodiment of the present invention. Diagram 500 includes timeslices 502a-b, 504a-b, 508, and 510, and paging time 506. The timeslices of diagram 500 corresponds to command buffers and thus diagram 500 depicts command buffers representing timeslices which execute until preempted.

Paging time 506 depicts a paging operation (e.g., by an operating system) in between timeslices (e.g., timeslices 504a and 502b). For example, paging time 506 may correspond to memory movement work that is submitted by the operating system to prepare for timeslice 502b (TS0) now that timeslice 504a (TS1) has been moved out of the GPU (e.g., node of the GPU).

In one exemplary embodiment, timing diagram 500 shows execution order and depicts two applications which have been serialized to a command stream on a single node under WDDM 1.0. Timeslices 502a-b and 504a-b each correspond to respective contexts. For example, timeslices 502a-b and timeslices 504a-b may be based on requests from a first application (e.g., application0), context A and a second application (e.g., application1), context B, respectively. Timeslices 508 and 510 may each correspond to respective contexts (e.g., for application0).

FIG. 6 shows a data diagram of exemplary semaphores and methods, in accordance with one embodiment of the present invention. Diagram 600 includes methods 602-604 and semaphores 606. Diagram 600 depicts a stream of methods and semaphores of a command buffer sent to a GPU from a user mode driver (e.g., user mode driver 306) and a kernel mode driver (e.g., kernel mode driver 312). Methods 602 and 604 may correspond to commands written by a user mode driver.

Semaphores 606 comprises release synchronization semaphore 608a and acquire synchronization semaphore 608b. In one embodiment, release synchronization semaphore 608a is written by the GPU at the end of a command buffer. A kernel mode driver accesses release synchronization semaphore 608a to determine when a command buffer has completed. Acquire synchronization semaphore 608b may be written by the kernel mode driver and is accessible (e.g., readable) by the user mode driver to determine when a command buffer has completed.

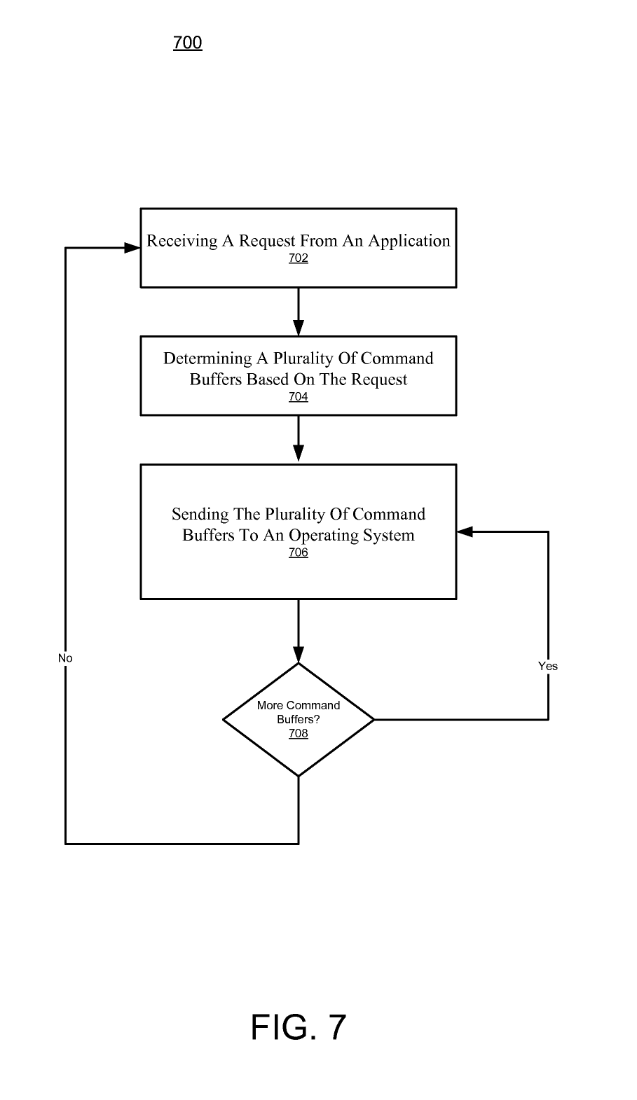

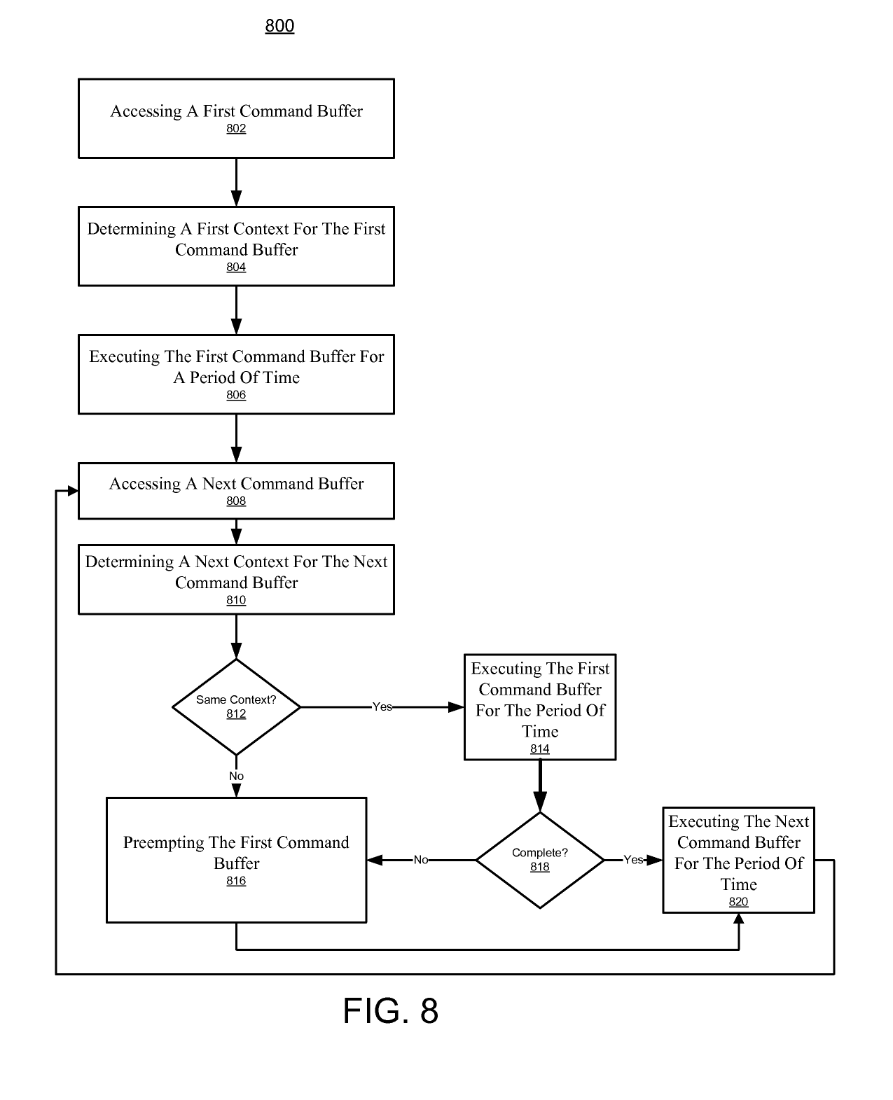

With reference to FIGS. 7 and 8, flowcharts 700 and 800 illustrate example functions used by various embodiments of the present invention. Although specific function blocks (“blocks”) are disclosed in flowcharts 700 and 800, such steps are examples. That is, embodiments are well suited to performing various other blocks or variations of the blocks recited in flowcharts 700 and 800. It is appreciated that the blocks in flowcharts 700 and 800 may be performed in an order different than presented, and that not all of the blocks in flowcharts 700 and 800 may be performed.

FIG. 7 shows a flowchart of an exemplary computer controlled process for processing requests in accordance with one embodiment for timeslicing GPU tasks using a command buffer architecture. Flowchart 700 may be performed by a user mode driver (e.g., user mode driver 306).

At block 702, a request from an application is received. The request may correspond to work that an application (e.g., applications 302-304) has requested for execution on a graphics processing unit (GPU). As described herein, the application may be a compute application.

At block 704, a plurality of command buffers based on the request are determined. In one embodiment, each of the plurality of command buffers corresponds to a portion of execution time or timeslice for the work. Each of the plurality of command buffers may comprise an allocation identifier (AID) corresponding to a context associated with the request. Each of the plurality of command buffers may further comprise a plurality of memory allocations.

At block 706, the plurality of command buffers are sent to an operating system. In one embodiment, the operating system is operable for scheduling the plurality of command buffers for execution. The operating system may have a predetermined execution time limit for each of the plurality of command buffers. The sending may comprise sending a portion of the plurality of command buffers at a predetermined interval (e.g., at a heartbeat interval). In one embodiment, a user mode driver may submit a plurality of command buffers for a particular or corresponding context to the operating system.

Embodiments of the present invention support a plurality of applications submitting streams of requests to a user mode driver. The operating system submits command buffers to the hardware (e.g., GPU) and can interleave them between each other. Thus, embodiments of the present invention support interleaving long running compute applications and interactive graphics applications.

At block 708, whether there are more command buffers to be submitted to the operating system is determined. If there are more command buffers to be submitted to the operating system, block 706 is performed. In one embodiment, another set of command buffers (e.g., another heartbeat of buffers) may be submitted. If there are no more command buffers to be submitted to the operating system, block 702 is performed.

FIG. 8 shows a flowchart of an exemplary computer controlled process for executing a plurality of command buffers in accordance with one embodiment of the present invention for timeslicing GPU tasks using a command buffer architecture. Flowchart 800 may be performed by a kernel mode driver (e.g., kernel mode driver 312).

At block 802, a first command buffer is accessed. At block 804, a first context for the first command buffer is determined.

At block 806, the first command buffer is executed for a period of time. The period of time may correspond to a predetermined length of time or timeslice.

At block 808, a next (e.g., second) command buffer is accessed. The first and the next command buffer may be scheduled for execution by an operating system. The first and the next command buffers may comprise memory allocations. The first command buffer and the next command buffer may each comprise a respective allocation identifier (AID) (e.g., corresponding to a respective context). At block 810, a next context for the next command buffer is determined.

At block 812, whether the first context and the next context are the same is determined. The first and the next context may be the same context (e.g., both from a compute application) or may be different contexts (e.g., the first command buffer is based on a compute application and the next command buffer is based on a graphics application). If the first context and the next context are the same context, block 814 is performed. If the first context and the next context are different contexts, block 816 is performed.

At block 814, the first command buffer is executed for the period of time. In other words, when the first context is the same as the second context, the first context is allowed to continue executing.

At block 816, the first command buffer is preempted. In one embodiment, the first command buffer is preempted when the second context is different from the first context. As described herein, embodiments of the present invention support preemption of a command buffer and executing of the next command buffer for a period of time. Embodiments of the present invention further support preemption based on priority (e.g., small compute applications and interactive graphics applications may have a higher priority than long running compute applications).

At block 818, whether the command buffer executing is complete is determined. If the first command buffer is complete, block 820 is performed. If the first command buffer is not complete, block 816 may be performed if there is another command buffer of with a context different from the first context.

At block 820, the next command buffer is executed for the period of time. In one embodiment, the next command buffer is executed for a timeslice after the first command buffer has completed.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of processing requests, said method comprising:
receiving a request from an application;
determining a plurality of command buffers required to execute said request, wherein each of said plurality of command buffers corresponds to some portion of execution time; and
sending said plurality of command buffers to an operating system operable for scheduling said plurality of command buffers for execution on a graphics processor, wherein said operating system has a predetermined execution time limit for each of said plurality of command buffers, and wherein command buffers from a different request are time multiplexed within the execution of said plurality of command buffers on said graphics processor.

2. The method as described in claim 1 wherein said sending comprises sending a portion of said plurality of command buffers at a predetermined interval.

3. The method as described in claim 1 wherein said request comprises work for execution on said graphics processor.

4. The method as described in claim 1 wherein each of said plurality of command buffers comprises an allocation identifier (AID) corresponding to a context associated with said request and wherein said AID corresponds to a plurality of memory allocations associated with said context.

5. The method as described in claim 1 wherein said plurality of command buffers is operable for execution in conjunction with a virtual memory system and a time for execution of said request is longer than said predetermined execution time limit.

6. The method as described in claim 5 wherein a plurality of commands for a graphics processing unit (GPU) associated with said plurality of command buffers are accessed directly by the GPU via a sideband mechanism.

7. The method as described in claim 1 wherein said application is a compute application.

8. A method of executing a plurality of command buffers, said method comprising:
accessing a first command buffer;
determining a first context for said first command buffer;
executing said first command buffer for a period of time on a graphics processor;
accessing a second command buffer, wherein said first command buffer and said second command buffer are scheduled by an operating system;
determining a second context for said second command buffer; and
executing said first command buffer for said period of time on said graphics processor when said first context is the same as said second context.

9. The method as described in claim 8 further comprising:
preempting said first command buffer when said second context is different from said first context.

10. The method as described in claim 8 wherein said first command buffer and said second command buffer correspond to a compute application.

11. The method as described in claim 9 wherein said first command buffer is based on a request from a compute application and said second command buffer is based on a request from a graphics application.

12. The method as described in claim 9 wherein said first command buffer and said second command buffer respectively comprise a plurality of memory allocations.

13. The method as described in claim 8 wherein said first command buffer and said second command buffer each comprise a respective context identifier.

14. A graphics processing system comprising:
a first module operable for receiving a plurality of requests for work to be completed on a graphics processor, wherein said first module is operable to determine a plurality of command buffers based on said plurality of requests and wherein each of said plurality of command buffers corresponds to a predetermined amount of execution time on said graphics processor; and
a second module operable for preempting a given command buffer executing on said graphics processor, wherein said second module is further operable to preempt a command buffer of said plurality of command buffers based on a context of said given command buffer.

15. The graphics processing system as described in claim 14 wherein said first module is operable for sending a portion of said plurality of command buffers at a predetermined interval.

16. The graphics processing system as described in claim 14 wherein said plurality of command buffers are operable to be scheduled by an operating system.

17. The graphics processing system as described in claim 14 wherein each of said plurality of command buffers comprises an allocation identifier (AID) corresponding to a context.

18. The graphics processing system as described in claim 14 wherein each of said plurality of command buffers comprises a plurality of memory allocations.

19. The graphics processing system as described in claim 14 wherein a plurality of commands for a graphics processing unit (GPU) associated with said plurality of command buffers are accessed directly by the GPU via a sideband mechanism.

20. The graphics processing system as described in claim 14 wherein said plurality of requests are from a compute application.
